(19) United States
(12) Patent Application Publication
(10) Pub. No.: US 2005/0034166 A1
(43) Pub. Date: Feb. 10, 2005

(54) Apparatus and method for processing multimedia and general internet data via a home media gateway and a thin client server

(76) Inventors: Hyun-Chul Kim, Suwon-si (KR); Young-Jip Kim, Suwon-city (KR); Jae-Seok Park, Seoul (KR); Young-Seop Han, Suwon-city (KR)

Correspondence Address: Robert E. Bushnell;Suite 300, 1522 K Street, N.W., Washington, DC, 20005, US

(21) Appl. No.: 10/900,360

(22) Filed: Jul. 28, 2004

(30) Foreign Application Priority Data
Aug. 4, 2003 (KR) 2003-53918

(51) Int. Cl. H04N 7/173; H04N 7/18

(52) U.S. Cl. 725/119; 725/78

(57) ABSTRACT

A home media gateway improving a thin client mode. General Internet data is separated from multimedia data and is processed differently and is sent to the home media gateway over a different channel to reduce the burden on the processor of the home media gateway. General Internet data is processed in a thin client server and the multimedia data is processed in a multimedia auxiliary processor of the home media gateway so that tasks to be processed by a main processor of the home media gateway can be reduced to a minimum and a load concentrated on the thin client server can be prevented. Also, since the multimedia auxiliary processor of the home media gateway directly processes multimedia data by hardware-based processing, there is an effect that the resulting processed multimedia data will have a quality better than if processed by software-based processing.

### CLAIM OF PRIORITY

This application makes reference to, incorporates the same herein, and claims all benefits accruing under 35 U.S.C. §119 from an application for APPARATUS AND METHOD FOR PROCESSING MULTIMEDIA DATA OF HOME MEDIA GATEWAY IMPROVING THIN CLIENT MODE earlier filed in the Korean Intellectual Property Office on 4 Aug. 2003 and assigned serial No. 2003-53918.

### BACKGROUND OF THE INVENTION

1. Field of the Invention

The present invention pertains to a home media gateway and, more particularly, to an apparatus and method for processing data in a home media gateway.

2. Description of the Related Art

In general, a home media gateway is a digital set top box connected to the Internet and to a display to display virtual variable images on the display, the images being downloaded off the Internet. Such a home media gateway can be used in services such as interactive TV as well as Video On Demand (VOD), image home shopping, and network games.

The home media gateway is connected to interactive TV or a network such as an image transmission service (for example, a video dial tone provided by a telephone service company of United States) or the like. The home media gateway is also connected to a TV monitor or the like at home. Such a set top box additionally has a function of receiving and converting image signals. The set top box or home media gateway can be connected to a telephone line or via a cable or CATV to receive the images.

Image and voice data for digital broadcasting are compressed with MPEG2, multiplexed in the form of a transmission stream (TS) and transferred on an xDSL. Here, the xDSL includes various kinds of lines such as ADSL, HDSL and VDSL. The VOD includes an Internet VOD which makes VOD contents on the Internet viewed with a Window Media Player or a Real Player. The VOD can be of different forms, including MPEG2. The MPEG2 VOD has also many forms where the VOD stream is multiplexed in the form of MPEG2 transmission stream packet and transmitted to the digital set top box in the ATM or instead using IP mode in the case of digital broadcasting.

The set top box for the Internet TV can be classified into a mode having a web browser and a mode using a thin client server. The set top box for the Internet TV adopting the built-in web browser processes Internet data received through the network using the built-in web browser, and displays the resulting images on the TV display monitor attached to the set top box. Since the set top box for the Internet TV using the web browser mode has to process the Internet data using the built-in web browser by itself, a high quality, high end, expensive CPU is required in this set top box.

A set top box that processes Internet data with a lower end CPU is a set top box for the Internet TV using the thin client mode. Here, the thin client is a client hardware devised for the purpose of reducing the total cost of ownership (referred to as TCO, hereinafter) in a client/server system by processing internet TV images without using a high end CPU. Further, the cost of the set top box can be further reduced by eliminating much of the software found in a fat client like an ordinary personal computer. Thus, the TCO can be reduced using a thin client with a lower end CPU. The thin client can reduce the TOC by restricting its function to only a man-machine interface process. The client hardware according to this idea includes a network computer (NC) developed by Oracle and Sun Micro System, a Net PC developed by Intel and Microsoft, and Window terminal developed by Microsoft. That is, “thin client” is a generic name for the new kind of computer.

In the set top box for the Internet TV using the thin client technology, a method is adopted in which substantial Internet data are processed in a high performance server outside the set top box, only the processed result is transmitted to the set top box, and the set top box displays the result of data process transmitted from the server on a TV screen. As a result, considering that a TV set top box that includes a built-in web browser requires a high quality, high end and expensive CPU, there occurs a problem that the higher quality CPU specification is required in order to process the Internet data smoothly. Also, the most serious defect of the set top box for the Internet TV of a thin client mode is that the set top box does not support for multimedia data sufficiently.

Also, while data processed in the thin client server is compressed again in order to reduce traffic between the thin client server and a client (the home media gateway) to transmit to the home gate away in the thin client mode, a compression method used in the thin client server has a problem that it is efficient when compressing and transmitting the screen information but the compression method in the thin client server is not efficient when compressing multimedia data for transmission to the set top box of the motion picture and sound data.

Also, since decoding (i.e., decompression) for multimedia contents is carried out in the thin client server, there occurs a problem that an arithmetic load is concentrated on the CPU of the thin client server and resulting in reduced performance for the entire system. Recently, even though a thin client mode in which a support for multimedia is supplemented is used, it is not proper to process high quality multimedia data. Also, considering that multimedia data is becoming more and more used in the transmission of TV and movies, this reliance and burden on the CPU of a set top box in the processing of multimedia data is problematical and very limiting.

### SUMMARY OF THE INVENTION

It is therefore an object of the present invention to provide an improved set top box or home media gateway.

It is also an object of the present invention to provide a home media gateway that can more efficiently process both Internet data and multimedia data obtained of the internet.

It is further an object to provide an apparatus for transferring, processing and displaying movies off the internet that does not require high end or expensive CPU.

It is still an object of the present invention to provide an improved process for transferring, processing and displaying both internet movie and TV data and multimedia movie and TV data taken off the internet via a thin client server and a home media gateway.

It is further an object of the present invention to provide a method for determining whether data is internet data or multimedia data and then processing said data for display based on said determination.

It is also an object to provide a method and an apparatus for a thin client server that reduces the processing burden on both the thin client server and the home media gateway.

These and other objects can be achieved by an apparatus and method for processing multimedia data of a home media gateway improving a thin client mode where general internet data and multimedia data are separated in a thin client server, and the general Internet data are processed in the server in the thin client mode and the multimedia data are processed in a multimedia auxiliary processor installed in the home media gateway so that data having important Internet data among the multimedia data are efficiently processed with even a lower-specification hardware. In other words, the above processing for video, TV, movies and sound can be achieved more efficiently by putting less burden on the CPU in the home media gateway and limiting the burden on the thin client server by identifying and processing the general Internet data in the thin client server and not in the home media gateway.

At the thin client server, the extension tag of the HTML source of the movie data is examined to determine if the movie data is characterized as multimedia data or general internet data. If it is determined to be general internet data, the data is processed at the thin client server before being sent to the home media gateway for display. If the movie data is multimedia data, the thin client server sent the data to the home media gateway, where a special processor in the home media gateway processes this movie data for display. By doing the above, the burden on the CPU on the home media gateway is reduced and the burden on the thin client server is limited, resulting in more efficient processing of movie and TV data and lower price for the components of the home media gateway.

### BRIEF DESCRIPTION OF THE DRAWINGS

A more complete appreciation of the invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a view illustrating a construction and a network connection of a home media gateway of a thin client technology;

FIG. 2 is a view illustrating a construction of a home media gateway and its connection for processing multimedia data through a thin client mode in accordance with the present invention;

FIG. 3 is an operational flow chart illustrating a data process procedure in a thin client server to perform a method for processing multimedia data of a home media gateway in accordance with the present invention;

FIG. 4 is an operational flow chart illustrating a method for processing multimedia data in a home media gateway in accordance with the present invention; and

FIG. 5 is a view illustrating a service flow for processing multimedia data in accordance with the present invention.

### DETAILED DESCRIPTION OF THE INVENTION

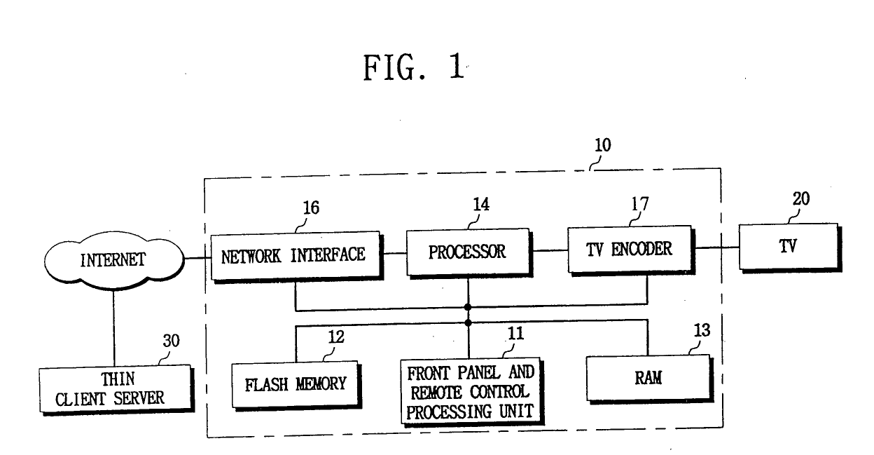

Turning now to FIG. 1, a set top box ( or home media gateway) for the Internet TV using thin client technology will be explained with reference to FIG. 1. FIG. 1 is a view illustrating a construction and a network connection of a home media gateway of a thin client technology. Referring to FIG. 1, a home media gateway (a set top box for an Internet TV) 10 is connected to a thin client server 30 through an Internet and is also connected to a TV display 20 which displays screen information transmitted from the thin client server 30. Here, an Internet connected between the home media gateway 10 and the thin client server 30 can be connected using as an xDSL or an Ethernet.

The home media gateway 10 may be made up of a front panel and remote control processing unit 11, a flash memory 12, a RAM 13, a processor 14, a network interface 15 and a TV encoder 16. The flash memory 12 and the RAM 13 store all programs and an operating system or OS for driving the processor 14, process key input and remote control signals for control of the home media gateway 10 and an Internet contents request which are inputted by a user on the front panel and remote signal processing unit 11, and provide the processed signals to the processor 14.

The network interface 16 interfaces with the Internet contents request signal required by the user to the thin client server 30, and compressed Internet contents data transmitted from the thin client server 30 through the Internet to the processor 14. Here, Internet contents information can be text data and multimedia data.

The processor 14 provides the network interface 16 with the Internet request signals inputted from the front panel and remote control processing unit 11, and decodes the compressed Internet contents data transmitted from the thin client server 30 through the network interface 16 and provides the decoded data to the TV encoder 17. The TV encoder 17 encodes decoded Internet contents information provided from the processor 14 to display the information on TV 20 and provides the TV 20 with the encoded information.

The thin client server 30 connects the corresponding contents to the web server through the Internet according to the contents request signal required by the home media gateway 10, and downloads the contents information requested by the user from the corresponding web server. Screen information among the contents information downloaded as described above is compressed and transmitted to the home media gateway 10 through the Internet. The multimedia contents (for example, motion picture and sound information) are decoded, and the decoded information is compressed again and transmitted to the home media gateway 10 through the Internet. Accordingly, the processor 14 of the home media gateway 10 decodes the compressed screen information transmitted form the thin client server 30, and displays the decoded information on TV display 20. Also, the processor 14 decodes the compressed multimedia contents information and displays it on a multimedia replay screen of the TV screen.

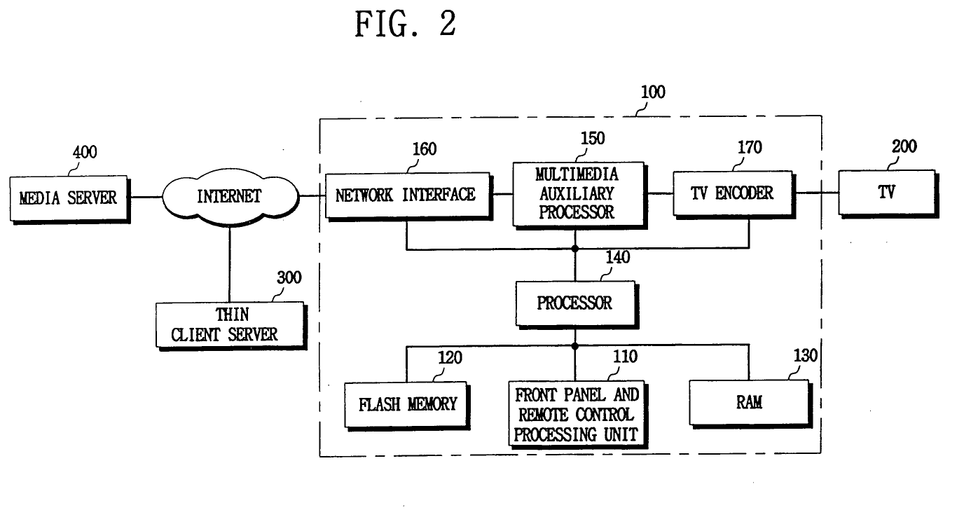

Turning now to FIG. 2, FIG. 2 illustrates a construction of a home media gateway and its connection for processing multimedia data through a thin client mode in accordance with the present invention. Explanations for the same constituents with those in FIG. 1 will be omitted.

As illustrated in FIG. 2, a home media gateway 100 may include a front panel and remote control processing unit 110, a flash memory 120, a RAM 130, a processor 140, a multimedia auxiliary processor 150, a network interface 160 and a TV encoder 170. The home media gateway 100 is connected to a thin client server 300 and a media server 400 through a network such as the Internet. Also, the home media gateway 100 is connected to a TV display 200 which displays contents information requested by a user.

When a contents request signal is received through the front panel and remote control processing unit 110, the processor 140 of the home media gateway 100 provides the network interface 160 with the corresponding contents request signal. The network interface 160 transmits the contents request signal to the thin client server 300 through a thin client protocol.

The thin client server 300 downloads the contents information from a corresponding web server through the Internet according to the contents request signal transmitted from the home media gateway 100. The thin client server 300 divides and classifies the downloaded contents information into general Internet data and multimedia data, and processes an HTML source for the divided general Internet data so as to generate screen information to be transmitted to the home media gateway 100. The generated screen information for the divided general Internet data is transmitted to the network interface 160 of the home media gateway 100 through one channel according to a thin client protocol mode. Also, information on multimedia data divided from the HTML source is transmitted, unprocessed, to the home media gateway 100 through a separate channel.

The network interface 160 of the home media gateway 100 provides the processor 140 with the screen information of general Internet data transmitted from the thin client server 300, and the processor 140 provides the TV encoder 170 with the screen information of general Internet data received from the network interface 160. Accordingly, the TV encoder 170 encodes the screen information of the general Internet data and then displays the screen information of the general Internet data on TV.

On the other hand, the processor 140 which receives the unprocessed multimedia data transmitted from the thin client server 300 through the separate channel has access to the media server 400 through the network interface 160 according to the information on the corresponding multimedia data and downloads the corresponding multimedia data. The downloaded and received multimedia data are provided to the multimedia auxiliary processor 150, and the multimedia auxiliary processor 150 decodes the multimedia data provided from the processor 140 and provides the decoded multimedia data to the TV encoder 170. Accordingly, the TV encoder 170 encodes the multimedia data provided from the multimedia auxiliary processor 150 and displays the encoded multimedia data on the TV display 200.

A detailed operation for the multimedia data processing unit of the home media gateway improving the thin client mode having such a construction in accordance with the present invention will now be explained. At first, Internet data requested by a user in the present invention are processed through an inter-working of a high performance server (thin client server 300) and an Internet TV set top box (home media gateway 100). When the user boots the home media gateway 100, the home media gateway 100 requests access to the thin client server 300 for a service.

When the thin client server 300 permits the access of the home media gateway 100 through an authentication procedure, two communication channels are formed between the home media gateway 100 and the thin client server 300. Here, one of the two communication channels is used to communicate using the thin client protocol, and the other is used to exchange the information on the multimedia data. The thin client protocol channel is used to transfer processed general internet data (i.e., screen information) to the home media gateway 100 for display. The other channel is used to transfer unprocessed multimedia data from the thin client server 300 to the home media gateway 100 for processing and display.

As illustrated in FIG. 2, the home media gateway 100 has the front panel and remote control processing unit 110 for receiving a user's commands and requests. The user can generate the event on the home media gateway through a wireless keyboard or a remote controller. When the user requests a display of specified Internet contents through the wireless keyboard or the remote controller, the user's request is inputted to the processor 140 of the home media gateway 100 through the front panel and remote processing unit 110 of the home media gateway 100. The processor 140 of the home media gateway 100 transmits the user's event to the thin client server 300 through the network interface 160 using the thin client protocol.

The thin client server 300 downloads the contents desired by the user from the corresponding web server through the Internet. Also, when the Internet contents desired by the user are downloaded, the thin client server 300 analyzes, classifies and divides the downloaded contents into general Internet data and multimedia data. That is, the thin client server 300 classifies the contents downloaded from the Internet into general Internet data to be processed in the thin client server 300 and the multimedia data to be processed in the multimedia auxiliary processor 150 of the home media gateway 100.

Now, a method for classifying received downloaded data at the thin client server 300 into either general Internet data or multimedia data will now be discussed. The thin client server 300 can divide received downloaded data into either general Internet data or multimedia data by analyzing the HTML source of the contents downloaded from the Internet. That is, the thin client server 300 can extract information on the multimedia data included in the HTML source by analyzing an HTML TAG and a link included in the HTML source.

A typical HTML TAG used when including the information on the multimedia data in the HTML source is ‘EMBED’ and ‘OBJECT’. Also, since links for the multimedia data included in the HTML source include extensions such as ‘wmv’, ‘asf’, ‘asx’, ‘mpg’ and ‘mp3’, it is possible to determine which information is multimedia data from the HTML source by analyzing the HTML TAG and the link.

When the extraction of the information on the multimedia data in the HTML source is finished, the thin client server 300 processes the HTML source classified as general Internet data and does not process data classified as multimedia data. The processed general Internet data (or screen information) and the unprocessed multimedia data are then transmitted to the home media gateway 100 using the thin client protocol channel and the multimedia channel, respectively.

The processor 140 of the home media gateway 100 receives the screen information (or processed general Internet data) transmitted from the thin client server 300 using the thin client protocol, carries out a decoding (decompression) of the received screen information, and provides the TV encoder 170 with the screen information. After encoding the screen information (general Internet data) provided from the processor 140 to be displayed on the TV 200, the TV encoder 170 provides the TV 200 with the screen information (general Internet data) to be displayed on the TV 200.

On the other hand, the processor 140 of the home media gateway 100 receives the unprocessed multimedia data transmitted from the thin client server 300 through a separate multimedia channel. A multimedia data process program installed in the processor 140 processes the unprocessed multimedia data by accessing a media server 400 through the Internet using the unprocessed multimedia information received from the thin client server 300 through the separate multimedia channel. Processor 140 then downloads the multimedia data from media server 400 over the internet and provides this downloaded data to the multimedia auxiliary processor 150 in home media gateway 100. The multimedia auxiliary processor 150 then decodes the downloaded multimedia data provided from the processor 140 and provides the TV encoder 170 with the multimedia data, and the TV encoder 170 displays the processed result of the multimedia auxiliary processor 150 through the TV 200.

As described above, the user can generate an event or a request via a wireless keyboard or a remote controller while the Internet contents are displayed on the TV 200. When the user generates the event, the processor 140 of the home media gateway 100 determines whether the event generated from the user is an event for the general Internet data or an event for the multimedia data. If the user's event is the event for the general Internet data, the processor 140 of the home media gateway 100 transmits the corresponding event to the thin client server 300 using the thin client protocol. The thin client server 300 receives the event or request transmitted from the home media gateway 100 using the thin client protocol, processes the received event, generates the screen information on the processed result and transmits the screen information to the processor 140 of the home media gateway 100 using the thin client protocol. The processor 140 displays the screen information transmitted from the thin client server 300 on TV 200 through the TV encoder 170, and the user can confirm the event process result through the TV 200.

On the other hand, when the event or request generated from the user is an event or request for the multimedia data, the processor 140 of the home media gateway 100 transfers the corresponding event to the multimedia process program installed in the processor 140 to process the event and then requests the multimedia data source by ordering a proper command to the multimedia auxiliary processor 150 or having access to the media server 400 on the Internet.

The multimedia auxiliary processor 150 receiving the multimedia event command processes the corresponding command properly and displays the processed result on the TV 200 using the TV encoder 170, and the user can confirm the processed result of the event on the TV.

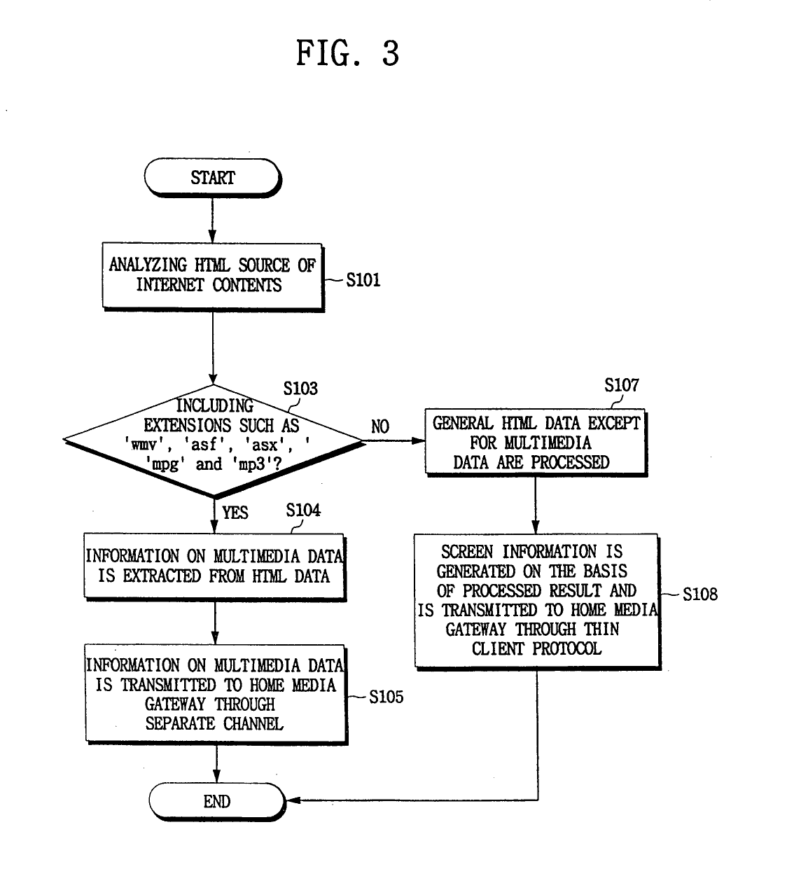

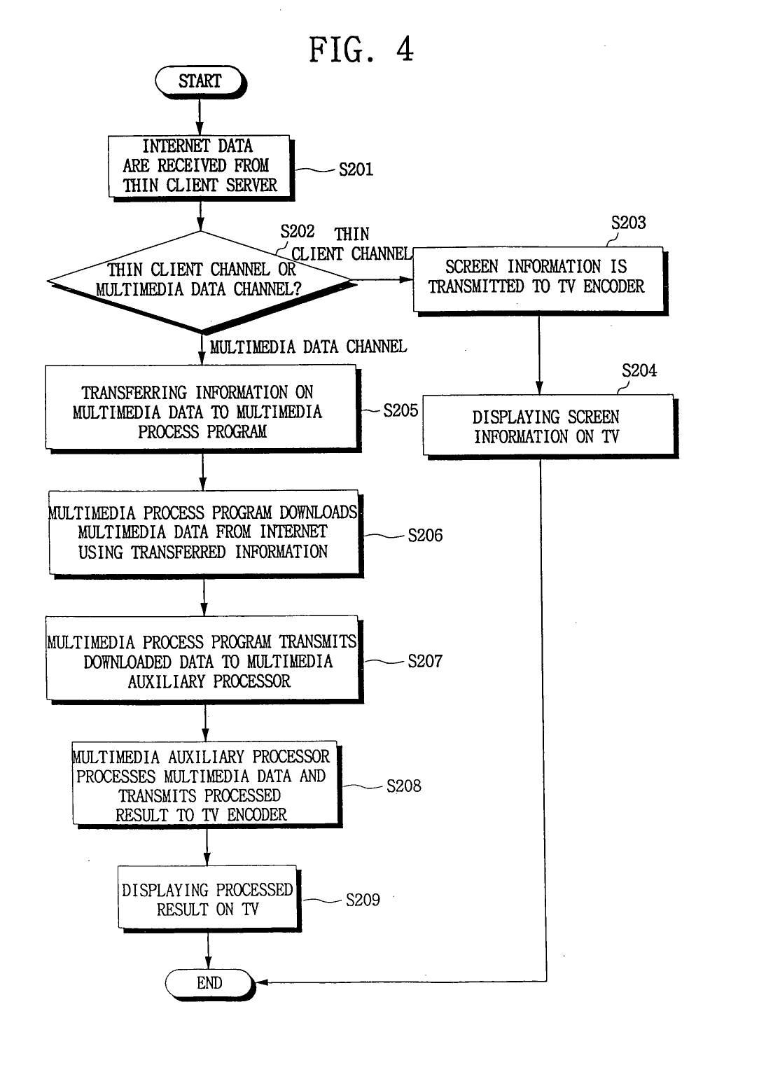

Hereinafter, a method for processing multimedia data in accordance with the present invention corresponding to an operation of an apparatus for processing multimedia data of a home media gateway using a thin client mode in accordance with the present invention described above will be explained step by step with reference to FIGS. 3 and 4. FIG. 3 is an operational flow chart illustrating a data process procedure in a thin client server to perform a method for processing multimedia data of a home media gateway in accordance with the present invention, and FIG. 4 is an operational flow chart illustrating a method for processing multimedia data in a home media gateway in accordance with the present invention.

At first, the data process procedure in the thin client server 300 when contents are requested from the home media gateway 100 will be explained with reference to FIG. 3. As illustrated in FIG. 3, when an Internet contents request is made from the home media gateway 100, the thin client server 300 downloads the Internet contents from the corresponding web server through the Internet. When the Internet contents are downloaded, the thin client server 300 analyzes an HTML source of the downloaded Internet contents (S101). As a result of the analysis, it is determined whether HTML data of the Internet contents include “EMBED” or “OBJECT” tag. It is then determined whether the downloaded HTML data includes an extension such as “‘wmv”, “asf’, “asx”, “mpg” and “mp3” (S103).

As a result of the determination, when the downloaded HTML data include at least one of the extensions of “wmv”, “asf”, “asx”, “mpg” and “mp3”, the corresponding data are determined as multimedia data and the information on the multimedia data is extracted from the HTML data (S104). The extracted information on the multimedia is transmitted to the home media gateway 100 through a separate multimedia channel unprocessed (S105).

When the corresponding data does not include the extensions such as “wmv”, “asf”, “asx”, “mpg” and “mp3” in step S103, it is determined that the downloaded HTML data are general Internet data to be processed in the thin client server 300 so that the general HTML data except for the multimedia data are decoded (S 107) at the thin client server 300. The screen information to be displayed on the TV is generated using the decoded general Internet data, and the generated screen information is transmitted to the home media gateway 100 through the thin client protocol (S108).

Consequently, the thin client server 300 downloads contents information requested by the home media gateway 100 from the Internet, analyzes the tag and extension of the link of the downloaded HTML data and separates the general Internet data to be processed in the thin client server 300 from the multimedia data to be processed in the multimedia auxiliary processor 150 of the home media gateway 100.

The separated general Internet data are decoded in the thin client server 300, and screen information on the corresponding data is generated so that the generated screen information is transmitted to the home media gateway 100 through one channel (for example, a thin client channel). The separated multimedia data is extracted from any general internet data and is transmitted to the multimedia auxiliary processor 150 of the home media gateway 100 through the separate channel (a multimedia data channel) so that the multimedia data can be processed in the home media gateway 100.

A procedure for processing data transmitted from the thin client server 300 in the home media gateway 100 is explained step by step with reference to the FIG. 4. As illustrated in FIG. 4, when Internet data is received from the thin client server 300 (S201), it is determined whether the received data is data received through a thin client channel or data received through a multimedia data channel (S202).

When the received data is data received through the thin client channel as a result of the determination, the processor 140 of the home media gateway 100 provides the TV encoder 170 of the home media gateway 100 with screen information transmitted from the thin client server 300 (S203). This data transmitted over the thin client channel is processed general internet data now considered screen data to be displayed. The TV encoder 170 encodes the screen information provided from the processor 140 and displays the screen information on the TV (S204).

However, when the data transmitted from the thin client server 300 is data to be received through the multimedia data channel, the processor 140 transfers information on the receiving multimedia data to a multimedia process program installed in the processor 140 (S205). The multimedia process program in the processor 140 is downloaded by connecting the multimedia data to the media server 400 using the information on the multimedia data (S206). with the downloaded multimedia data (S207), and the multimedia auxiliary processor 150 decodes the downloaded multimedia data provided from the processor 140 and provides the TV encoder 170 with the decoded multimedia data (S208). Accordingly, the TV encoder 170 encodes the multimedia data provided from the multimedia auxiliary processor 150 and then displays the multimedia data on the TV screen (S209).

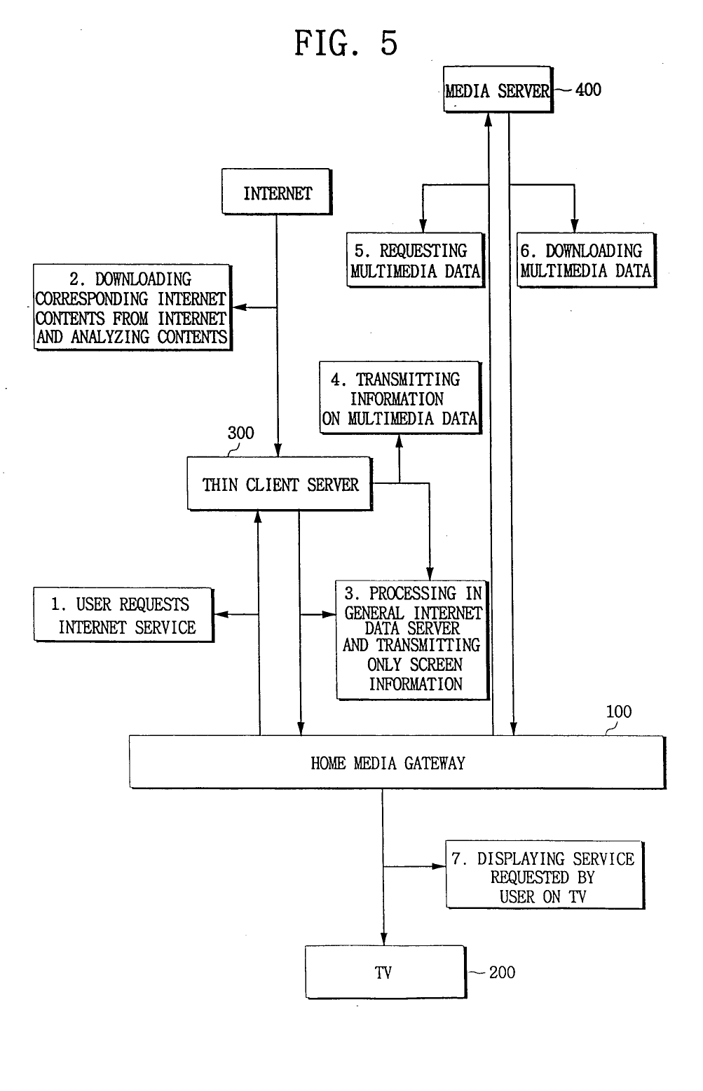

Service flow for an apparatus and method for processing the multimedia data of the home media gateway using the thin client mode in accordance with the present invention is summarized with reference to FIG. 5. FIG. 5 is a view illustrating a service flow for processing multimedia data in accordance with the present invention. As illustrated in FIG. 5, firstly, when an Internet service request is made by a user, the home media gateway 100 has access to the thin client server 300 to request the Internet service.

The thin client server 300 downloads Internet contents requested from the home media gateway 100 from an Internet, and then analyzes the downloaded Internet contents. That is, the thin client server 300 divides the downloaded Internet contents into general Internet data to be processed in the thin client server 300 and multimedia data to be processed in the multimedia auxiliary processor 150 of the home media gateway 100.

If the general Internet data and the multimedia data are separated from each other and classified, after the general Internet data is decoded in the thin client server 300, only screen information (decoded general Internet data) is transmitted to the home media gateway 100 through a thin client channel. Also, data classified as multimedia data is transmitted to the home media gateway 100 through the multimedia data channel in unprocessed form.

The home media gateway 100 displays the screen information transmitted from the thin client server 300 on the TV 200, and requests the media server 400 for the corresponding multimedia data using the information on the multimedia data. The media server 400 provides the home media gateway 100 with the multimedia data requested by the home media gateway 100. Accordingly, the home media gateway 100 decodes the multimedia data provided from the media server 400 and then displays the decoded multimedia data on the TV 200.

### Effects

An apparatus and method for processing multimedia data of a home media gateway improving a thin client mode in accordance with the present invention as described above have effects as follows.

Firstly, general Internet data are processed in the thin client server and the multimedia data are processed in the multimedia auxiliary processor of the home media gateway so that tasks to be processed by a main processor of the home media gateway can be reduced to a minimum. This is because the thin client server takes on the data processing burden by processing data considered as general Internet data. Accordingly, there is an effect that a specification of the main processor of the home media gateway can be remarkably reduced relative to a set top box of an existing Internet TV. Thus, it is not necessary to use a high end expensive CPU processor for the home media gateway when the thin client server can take on some of the processing burdens.

Secondarily, since a multimedia auxiliary processor of a home media gateway directly processes multimedia data by hardware-based processing, there is an effect that the processed multimedia data will have better quality than if this data were to be processed by software-based processing. Multimedia data is processed by an additional auxiliary processor instead of a main processor so that the main processor transacts common Internet data while the auxiliary processor exclusively transacts multimedia data so as to enhance the efficiency. The software-based processing and the hardware-based processing are different from each other as follows. The software-based processing requires high processing capability since multimedia data are decoded based upon software. The hardware-based processing transacts multimedia data decoding based upon hardware, which is previously established, so that the multimedia data can be decoded with a processor having a relatively low processing capability.

Thirdly, while the set top boxes of an Internet TV in the existing thin client mode depend on the thin client server to process all data, there is an effect that load concentration on the thin client server can be prevented since only general data can be processed in the server and the multimedia data can be processed by the home media gateway directly.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A home media gateway connected to a thin client server and a media server through a network, the home media gateway comprising:
a first data processing unit programmed and configured to:
enable a user to request an Internet service via thin client protocol to the thin client server so as to request corresponding Internet contents,
carry out decompression on screen information of general Internet data transmitted from the thin client server and provide said decompressed screen information to a display device, and
access and download multimedia data from the media server, the multimedia data corresponding to multimedia information received from the thin client server being downloaded from the media server; and
a second data processing unit programmed and configured to decode the multimedia data downloaded from the media server to the first data processing unit and then providing the display device the decoded multimedia data for display, said second data processing unit being distinguished from the first data processing unit.

2. The home media gateway of claim 1, further comprising a network interfacing unit, the network interface unit being adapted to form a plurality of communication channels with the thin client server when the home media gateway is booted, said network interfacing unit also being adapted to serve as an interface for to the first processing unit for the incoming screen information and the incoming multimedia data.

3. The home media gateway of claim 2, the plurality of communication channels comprise a thin client channel adapted to communicate with the thin client server using a thin client protocol, and a multimedia data channel adapted to exchange the information on the multimedia data with the thin client server.

4. The home media gateway of claim 1, further comprising an encoding unit which encodes the screen information and the multimedia data decoded in the first and second data processing units, respectively, and displays the information and data on the display device.

5. An apparatus for processing data in a thin client server connected to a home media gateway via a network, the thin client server comprising:
a downloading unit adapted to download an HTML source of corresponding contents from a corresponding web server when an Internet contents request is made from the home media gateway;
a data analyzing unit adapted to analyze the HTML source of the downloaded Internet contents by analyzing a tag and an extension of a link included in the corresponding HTML source; and
a data transmitting unit adapted to:
generate screen information on HTML data and transmit the generated screen information to the home media gateway when the HTML source analyzed by the data analyzing unit is general Internet data, and
extract multimedia data from the general Internet data and transmit the multimedia data to the home media gateway when the HTML source analyzed by the data analyzing unit is multimedia data.

6. The thin client server of claim 5, the data analyzing unit being adapted to determine the HTML data as the multimedia data in case that the extension of the link in the HTML source comprises one of ‘wmv’, ‘asf’, ‘asx’, ‘mpg’ and ‘mp3’, the data analyzing unit being adapted to determine the HTML data as general Internet data in case that the extension of the link included in the HTML source does not include ‘wmv’, ‘asf’, ‘asx’, ‘mpg’ and ‘mp3’.

7. The thin client server of claim 5, the data transmitting unit being adapted to form a plurality of communication channels to the home media gateway and being adapted to transmit the generated screen information on the general internet data and the extracted information on the multimedia data to the home media gateway through separate channels.

8. An apparatus for processing multimedia data using a thin client mode, the apparatus comprising:
a thin client server arranged to analyze a tag and an extension of a link which are included in an HTML source of an Internet contents downloaded by downloading the HTML source of corresponding contents from a corresponding web server, separating general Internet data from multimedia data based on said analysis, and transmitting screen information on general Internet data and information on multimedia data through different channels to the home media network; and
a home media gateway adapted to display the screen information transmitted from the thin client server and adapted to download a multimedia data source corresponding to the information on the multimedia data from a media server, and displaying the multimedia data source on a display device, wherein the home media gateway comprises:
a first processor programmed and configured to request corresponding Internet contents by being connected to the thin client server through a thin client protocol, decode the screen information on the general Internet data transmitted from the thin client server through one channel, display the decoded screen information on the display device, and download the multimedia data corresponding to the information on the multimedia data transmitted from the thin client server through the other channel from the media server; and
a second and different processor programmed and configured to decode the multimedia data downloaded from the media server by the first processor for display on the display device.

9. The apparatus according to claim 8, wherein the thin client server is arranged to determine HTML data as the multimedia data in case that an extension of a link included in the HTML source includes at least one of ‘wmv’, ‘asf’, ‘asx’, ‘mpg’ and ‘mp3’, and determines the HTML data as the general Internet data in case that the extension of the link included in the HTML source does not include ‘wmv’, ‘asf’, ‘asx’, ‘mpg’ and ‘mp3’.

10. A method for processing multimedia data using a home media gateway connected to a thin client server via a network, the method comprising:
forming a thin client channel and a multimedia data channel between the thin client server and the home media gateway when the home media gateway is booted, then;
making an Internet service request by a user;
sending the Internet service request to the thin client server via said thin client channel using a thin client protocol;
requesting corresponding Internet contents;
transmitting screen information on general Internet data from the thin client server to the home media gateway;
decoding the transmitted screen information of the general Internet data;
displaying the screen information on a display device;
transmitting multimedia data from the thin client server to the home media gateway over a multimedia data channel;
downloading multimedia data corresponding to the transmitted multimedia data transmitted from the thin client server from a media server to a first processor in the home media gateway;
decoding the downloaded multimedia data using a second and different processor in the home media gateway; and
displaying the decoded multimedia data on the display device.

11. A method for processing multimedia data using a thin client server connected to a home media gateway through a network, the method comprising:
downloading an HTML source of corresponding contents from a corresponding web server when an Internet contents request is made from the home media gateway;
analyzing the HTML source of the downloaded Internet contents by analyzing a tag and an extension of a link included in the corresponding HTML source;
generating screen information on HTML data and transmitting the generated information to the home media gateway through a thin client channel when the analyzed HTML source is general Internet data; and
extracting information on the multimedia data and transmitting the information to the home media gateway through a multimedia data channel when the analyzed HTML source is the multimedia data.

12. The method of claim 11, wherein the step for analyzing the tag and the extension comprises determining whether HTML data is multimedia data by examining the tag included in the HTML source to determine whether the extension of the link comprises one of ‘wmv’, ‘asf’, ‘asx’, ‘mpg’ and ‘mp3’ and classifying the HTML source as multimedia data when the extension tag comprises one or more of ‘wmv’, ‘asf’, ‘asx’, ‘mpg’ and ‘mp3’ and classifying the tag as general Internet data when the extension tag does not comprise one or more of ‘wmv’, ‘asf’, ‘asx’, ‘mpg’ and ‘mp3’.

13. A method for processing multimedia data and general internet data using a thin client server and a home media gateway, the method comprising:
forming a thin client channel and a multimedia data channel between the thin client server and the home media gateway when the home media gateway is booted, then;
sending a service request to the thin client server via a thin client protocol and requesting corresponding Internet contents when an Internet service request is made by a user in the state that the channels have been formed;
downloading an HTML source of the corresponding contents from a corresponding web server to the thin client server in response to the request;
analyzing the HTML source of the downloaded Internet contents and then analyzing a tag and an extension of a link included in the corresponding HTML source to determine whether the Internet contents are general Internet data or multimedia data;
generating screen information on HTML data according to the analysis result, transmitting the screen information to the home media gateway through the thin client channel when the Internet contents are general Internet data;
transmitting information on the multimedia data to the home media gateway through the multimedia data channel without generating screen information when the Internet contents are multimedia data;
after decoding screen information on general Internet data transmitted from the thin client server through the thin client channel, displaying the screen information on a display device;
downloading the multimedia data corresponding to the information on the multimedia data transmitted through the multimedia data communication channel from a media server to a first processor in the home media gateway; and
decoding multimedia data downloaded from the media server to the first processor via a second processor in the home media gateway; and then
displaying the decoded multimedia data on the display device.

14. The method of claim 13, the step of analyzing the HTML source comprises looking for one or more of ‘wmv’, ‘asf’, ‘asx’, ‘mpg’ and ‘mp3’ in the extension tag of the HTML source and classifying data as general Internet data when none of the extensions ‘wmv’, ‘asf’, ‘asx’, ‘mpg’ and ‘mp3’ are present and classifying data as multimedia data when one or more of the extensions ‘wmv’, ‘asf’, ‘asx’, ‘mpg’ and ‘mp3’ are present.
